(19) United States
(12) Patent Application Publication
(10) Pub. No.: US 2004/0097185 A1
(43) Pub. Date: May 20, 2004

(54) Magnesium-alloy vent door for vehicle HVAC system

(76) Inventors: Richard Hoyle, Orion, MI (US); Norman Golm, Rochester Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/295,381

(22) Filed: Nov. 15, 2002

(51) Int. Cl. B60H 1/00

(52) U.S. Cl. 454/69

(57) ABSTRACT

A door for use in a vehicle HVAC system is formed to have a portion preferably formed of a magnesium alloy. In one embodiment, the magnesium alloy forms a sub-frame, and a plastic is placed over said sub-frame. In a second embodiment, the door is formed entirely of the alloy

### BACKGROUND OF THE INVENTION

This invention relates to a unique HVAC door construction for controlling the flow of air through a vehicle HVAC system, wherein the door is preferably formed at least partially of a magnesium alloy.

Vehicle HVAC systems include alternate flow paths. Selectively movable items, known as “doors” control the flow through the various paths. As an example, to control the air temperature reaching the vehicle cab, some mixing of warm and cooler air is necessary. Typically, a door is driven by a motor under the control of a HVAC system control to pivot to a position such that it provides an appropriate mix of warm and cooler air to achieve a desired air temperature in the cab. Within the context of this application, the term “motor” should be understood to include doors that are actuated with an intermediate cable or vacuum actuator. That is, “motor” is utilized broadly to describe any method of moving the door between its selected positions.

Another use of such doors is directing the flow outwardly into the cab at either foot level, an upper level, or the defrost vent. Again, the door is selectively controlled based upon an operator's desired direction for the air flow to control the direction the air flows through at least a pair of alternate paths.

To date, these doors have typically been molded of plastic. Plastic has not always been sufficiently strong. Moreover, and particularly when exposed to heated air, the plastic has not always retained its shape to the extent desirable. As the plastic doors deform, some leakage can occur.

It is an object of this invention to form a door which is formed at least partially from a metal, and most preferably from a magnesium alloy.

### SUMMARY OF THE INVENTION

In a disclosed embodiment of this invention, a door for a vehicle HVAC system comprises at least a portion formed of a metal. Most preferably, the metal is a magnesium alloy.

In one embodiment, an underlying metal frame provides strength and rigidity to the door. An elastomer is placed over this underlying metal frame. In this embodiment, the metal is preferably a magnesium alloy.

In a preferred embodiment, an elastomer sheet receives the frame and is folded about the frame to form the final door. However, the elastomer could be molded over the frame in alternative embodiments.

In another embodiment, the door is formed entirely of the magnesium alloy.

The underlying metal portion provides additional rigidity and resistance to heat such that the door retains its shape. Thus, this invention improves upon the prior art. These and other features of the present invention can be best understood from the following specification and drawings, the following of which is a brief description.

### BRIEF DESCRIPTION OF THE DRAWINGS

FIG. 1 is a schematic view of a vehicle HVAC flow path.

FIG. 2 is a top view of an inventive door.

FIG. 3 is a cross-sectional view along line 3-3 as shown in FIG. 2.

FIG. 4 is a top view of a second embodiment door.

### DETAILED DESCRIPTION OF THE PREFERRED EMBODIMENT

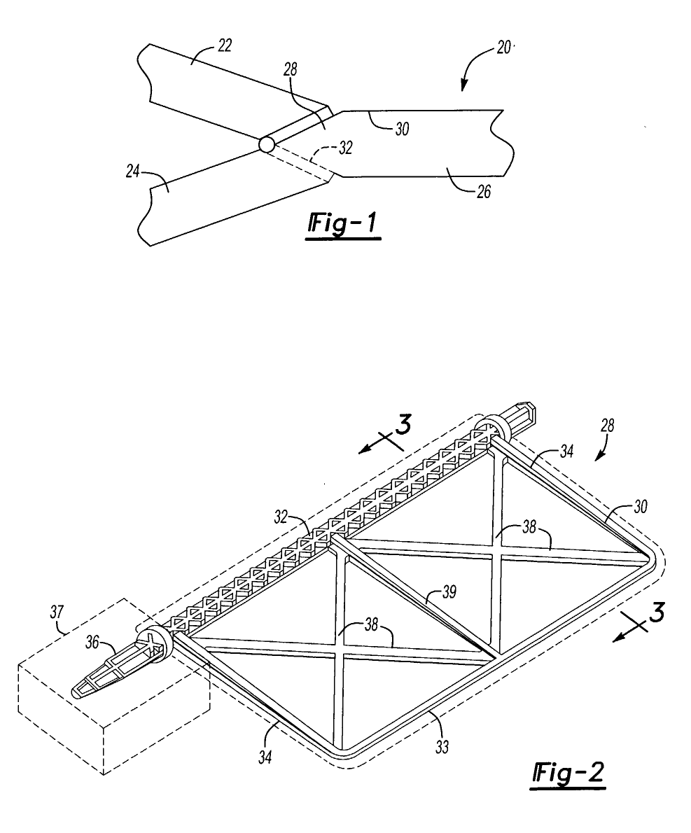

FIG. 1 shows a schematic 20 of a selectable air flow in a vehicle HVAC system. In particular, a pair of paths 22 and 24 communicate with a single path 26. In one application, the paths 22 and 24 respectively carry warm and cool air which is being mixed before being delivered to the outlet 26 leading to the vehicle cab. In a second embodiment, the line 26 may be leading from a source of heated or cooled air and the two paths 22 and 24 could be to the foot level of the cab occupant, or an upper region, respectively. In either case, door 28 pivots on a pivot point 30, and is typically driven by a motor controlled by a control to move between the illustrated position, position 32 shown in phantom, or some intermediate position. By controlling the position of the door 28, the control is able to either mix the cool or hot air 22 and 24, or deliver the air from line 26 to the desired location.

The inventive door 28 is shown in FIG. 2. As shown, an underlying metal frame 30 has upper side 32, lower side 33 and lateral sides 34. As shown, upper side 32 is larger than lower side 33. A pin 36 is connected to a motor 37, shown schematically, to mount a motor to drive the door. Crossing ribs 38 extend between the sides 32 on each side of a central brace 39.

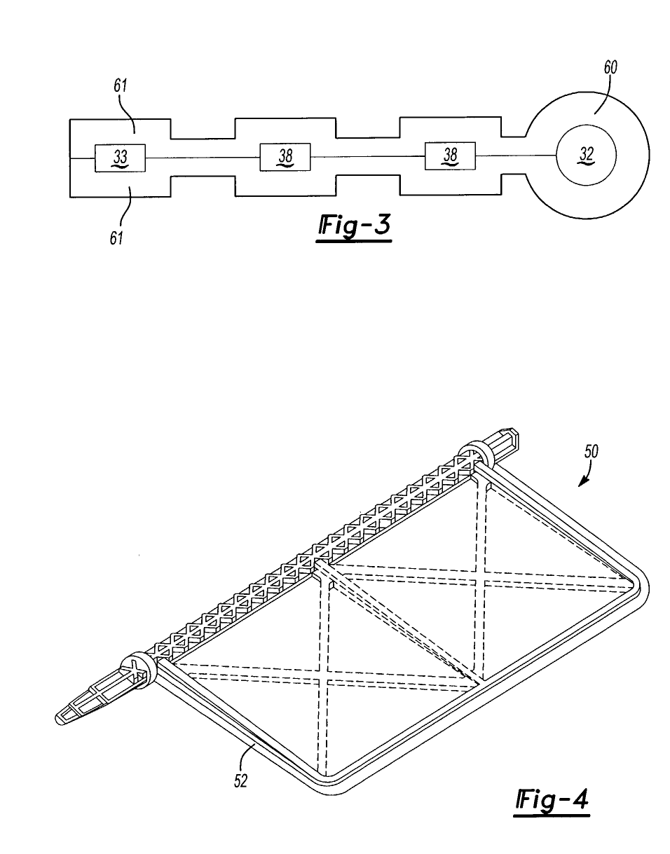

As shown in FIG. 3, a plastic 40 is formed over the underlying metal frame 30. The plastic and metal frame together provide a door 28 which is resistant to heat, and better retains its shape over time. Moreover, the door is sufficiently strong such that it will be able to withstand the stresses and strains that it will encounter as it is being driven. Also, the magnesium alloy provides a lightweight door. As shown, the plastic could be placed over the underlying frame in the form of a sheet 60 which is folded to have two sides 61 come together and be secured to said underlying frame. The sheet would preferably have some adhesive to secure the two sides 61 together.

Another embodiment 50 is shown in FIG. 4. In embodiment 50 the door is formed entirely of a metal, and most preferably a magnesium alloy. A rubber gasket 52 is preferably molded around the perimeter of the door to provide a seal.

In one preferred embodiment, the magnesium alloy is known as AZ391 alloy. The plastic molded over the FIGS. 2 and 3 embodiment is preferably an elastomer, preferably a thermoformed elastomer, and preferably one available under the trade name Santoprene™ available from Solvay Corp.

While preferred embodiments of this invention have been disclosed, a worker of ordinary skill in this art would understand that several modifications would come within the scope of this invention. For that reason the following claims should be studied to determine the true scope and content of this invention.

1. A vehicle HVAC flow system comprising:
a pair of paths, with a door being selectively pivotable to control flow within said two paths; and
said door being formed at least partially of a magnesium alloy.

2. A vehicle HVAC system as recited in claim 1, wherein said door has an underlying magnesium alloy frame, and plastic is placed over said underlying frame.

3. A vehicle HVAC system as recited in claim 2, wherein said frame includes an outer rectangular frame.

4. A vehicle HVAC system as recited in claim 3, wherein crossing ribs cross between said outer frame.

5. A vehicle HVAC system as recited in claim 4, wherein said plastic is an elastomer.

6. A vehicle HVAC system as recited in claim 2, wherein said plastic is an elastomer.

7. A vehicle HVAC system as recited in claim 2, wherein said plastic is a sheet placed about same frame.

8. A vehicle HVAC system as recited in claim 1, wherein said door is formed entirely of said magnesium alloy.

9. A vehicle HVAC system comprising:
a pair of paths, with a door being selectively pivotable to control flow within said two paths; and
said door being formed at an underlying metal frame having plastic placed over said underlying metal frame.

10. A vehicle HVAC system as recited in claim 9, wherein said frame includes an outer rectangular frame.

11. A vehicle HVAC system as recited in claim 10, wherein crossing ribs cross between said outer frame.

12. A vehicle HVAC system as recited in claim 11, wherein said plastic is an elastomer.

13. A vehicle HVAC system as recited in claim 9, wherein said plastic is formed in a sheet which is placed over said underlying metal frame.

14. A vehicle HVAC system as recited in claim 9, wherein said plastic is an elastomer.
